(19) United States
(12) Patent Application Publication
(10) Pub. No.: US 2022/0404549 A1
(43) Pub. Date: Dec. 22, 2022

(54) LATERAL WAVEGUIDE PHOTODETECTOR COUPLER

(71) Applicant: VEO PHOTONICS, INC., San Diego, CA (US)

(72) Inventors: Robert B. Welstand, San Diego, CA (US); Chen-Kuo Sun, Escondido, CA (US); Grace A. Sun, Escondido, CA (US)

(21) Appl. No.: 17/354,732

(22) Filed: Jun. 22, 2021

(51) Int. Cl. G02B 6/125; G02B 6/122

(52) U.S. Cl. CPC G02B 6/125; G02B 6/1228; G02B 2006/12147

(57) ABSTRACT

A waveguide coupler includes a coupling section which evanescently couples an optical signal, received from an input waveguide, with an absorbing waveguide. Structurally, the coupling section is an elongated waveguide with one end butt-coupled to the input waveguide. Further, the coupling section defines an engagement side edge which is positioned at a predetermined distance from a dimensionally compatible side surface area of the absorbing waveguide. In this combination, evanescence from the optical signal is directed laterally from the coupling section, through the engagement side edge of the coupling section, and through an assisting component, to the absorbing waveguide for use with a photodetector.

### FIELD OF THE INVENTION

The present invention pertains to photonics. More specifically, the present invention pertains to systems and methods that utilize integrated optics and waveguide photodetectors. The present invention is particularly, but not exclusively, useful as a waveguide coupler where an optical signal is transferred from an integrated waveguide into a waveguide photodetector.

### BACKGROUND OF THE INVENTION

Communication and sensing applications in fiber-optic systems historically used surface-normal photodetectors due to their ease of layered fabrication, high-power handling capability, and inherent polarization-insensitivity. Natural optical modes in fiber take on polarization states that are primarily perpendicular to the direction of propagation in the fiber due to its axial symmetry. When light launched from a fiber is incident on a surface-normal photodetector, the polarization lies in the plane of the detector surface and parallel to its underlying layers, unless the fiber is presented with a tilt angle. Among various photonics platforms (Silicon, Silicon-Germanium, Silicon-Nitride, III-V, and II-VI), very few materials possess a sufficiently large absorption coefficient to detect >98% of surface-normal incident optical power within micron or sub-micron distances also required to achieve high-speed operation.

As bandwidth requirements have increased into the tens and hundreds of GHz and beyond, waveguide photodetectors are indicated to achieve high-speed operation and distribute the absorption over longer propagation lengths, allowing more material choices and device designs suitable for semiconductor integration. Waveguide photodetectors are routinely designed and made to have propagation lengths of a few to tens of microns, although 50% of light absorption occurs within a propagation distance approximately or less than one micron, which results in localized high optical intensity, large concentrations of photo-generated carriers, and absorption saturation at incident optical powers beyond a threshold. Therefore, a need exists to increase useful incident optical power in waveguide photodetectors prior to onset of saturation for high power applications.

Waveguides and waveguide photodetectors integrate well into commercial and defense photonics platforms, which offer a variety of components needed to construct complex optical processing devices. The layered construction and processing often result in waveguides with rectangular or trapezoidal cross-section, sometimes with large or small width to height aspect ratios. Light propagating in integrated waveguides travels at a group velocity dependent on whether the optical polarization is primarily transverse electric (TE) or transverse magnetic (TM) and the natural optical modes are strongly dependent on the geometries and index profiles of the waveguide construction.

Coupling from integrated waveguides into other integrated components of different geometry or index often exhibit polarization-selective responses due to modal mismatch. Transitions from an input waveguide to another integrated component can tailor geometries and indices of refraction to overcome the modal mismatch, often only for one polarization. Presently, state-of-the-art high-speed waveguide photodetectors suffer modest polarization sensitivity when light is coupled from an integrated input waveguide, favoring either TE or TM polarization. Therefore, a need exists to improve the polarization selectivity of coupling input waveguides to absorbing waveguide photodetectors.

Butt-coupling and evanescent coupling approaches for waveguide photodetectors are disclosed for example in the article Virot, et. al., “High-performance waveguide-integrated germanium PIN photodiodes for optical communication applications,” Photon. Res., Vol. 1, No. 3, (2013). Butt-coupling results in large optical intensity in the absorbing waveguide proximal to the coupling waveguide with high absorption efficiency, but often suffers from one or more issues: optical power saturation at low incident powers, a strong back-reflection due to the significant difference between waveguide effective indices, and polarization sensitivity due to modal mismatch. Several prior art disclosures (U.S. Ser. No. 10/134,937, US2018/0301570A1, US2019/0019903A1, US2019/0353845A1) indicate evanescent coupling from an input waveguide into a light-absorbing layer for which the coupling interaction is at an angle that is particularly vertical in arrangement, characterized by one waveguide overlaying or aligned over the other. Vertical evanescent coupling reduces coupling strength, for example as in Virot by a factor of 1.7, which directly increases the required length to absorb the same amount of light. In US2019/0353845A1, the arrangement of the absorbing layer at Brewster's angle reduces the back-reflection of TE polarized light, but increases the back-reflection for TM polarized light. In all of these approaches, the input waveguide and absorbing waveguide are broadside-coupled and thus intrinsically and strongly coupled, thereby forming a composite waveguide with a composite index of refraction, due to the particularly vertical arrangement of the input waveguide and the absorbing waveguide.

Lateral evanescent coupling is known for transfer of optical energy between transmitting waveguides, both having propagating modes, when positioned laterally in close proximity to each other. For example, a directional coupler transfers optical power at a fixed ratio between two laterally positioned waveguides with a fixed separation to each other over a specified interaction length.

### SUMMARY OF THE INVENTION

With the above in mind, and specifically for mitigating and/or overcoming the shortcomings noted above, it is an objective of the present invention to provide a solution to increase the optical power saturation threshold of light coupled from integrated input waveguides into waveguide photodetectors, while also maintaining a small overall area to achieve high speed of operation. Another objective of the present invention is to overcome the polarization-dependence of coupling from integrated input waveguides into waveguide photodetectors, while also maintaining small back-reflection. Still another objective of the present invention is to provide a waveguide coupler that is convenient to use, relatively simple to manufacture and comparatively cost effective.

The invention consists of: an input waveguide carrying the optical signal, the input waveguide having an exit end; an elongated coupling section having a first end and a second end, wherein the first end of the coupling section is butt-coupled with the exit end of the input waveguide for receiving the optical signal therefrom with a propagating mode extending along a length L_{cs} between the first and second ends of the coupling section, wherein the coupling section defines an engagement side edge where evanescence from the optical signal is directed laterally from the coupling section and through the engagement side edge thereof; and an absorbing waveguide, wherein the absorbing waveguide includes an absorbing component made of a high-loss material and an assisting component made of a low-loss material, and having a side surface area, wherein the side surface area of the absorbing waveguide is in side-by-side contact with the engagement side edge of the coupling section along the length L_{cs}, for tracking therewith to evanescently couple the optical signal from the coupling section to the laterally displaced absorbing component of the absorbing waveguide.

The invention achieves its several goals in part by spatially separating incident light coupling and absorbing waveguide coupling functions through the length of the coupling section. In one embodiment, the coupling section is continuous in material and piecewise continuous in shape with the input waveguide, wherein the optical mode propagating in the input waveguide efficiently couples into a propagating mode in the coupling section that possesses a small or negligible modal overlap with the dominant absorbing modes in the absorbing waveguide. The absence of a strong index contrast presented to the propagating mode in the coupling section results in very low back-reflection, low modal mismatch, and minimal selectivity to polarization at the interface between the input waveguide and the coupling section. The lateral evanescent coupling between the propagating mode in the coupling section and adjacent absorbing waveguide's natural modes allow for design of a near-critical coupling, which minimizes multi-path energy transfer between waveguides and further reduces back-reflection.

The extent of lateral evanescent coupling is controlled primarily by the separation distance dj between the coupling section engagement side edge and the absorbing component side edge, which can be varied along L_{cs}. The coupling factor, a percentage measure of optical power transferred from the coupling section to the absorbing waveguide is chosen to be weak over the first several microns of interaction with the absorbing waveguide most prone to optical saturation. A weak coupling factor results in a very gradual and continuous evanescent coupling of light into the absorbing waveguide that decreases optical intensity and increases optical power saturation threshold. Increasing the coupling factor as a function of distance along the length L_{cs} results in a uniform absorption power distribution along the entire length.

In the preferred embodiment, the lateral coupling factor is varied as a function of distance through successive portions of the coupling section by geometric design, whereby an increasing lateral coupling factor to the absorbing waveguide results. The increasing lateral coupling factor in this embodiment increases absorption efficiency in portions further away from the input waveguide, where optical power has been reduced due to absorption nearer to the input. Increasing the absorption strength for light continuously or in steps towards the far end of the absorbing waveguide minimizes the total coupling section length Ls required to absorb the propagating light, and increases optical power handling capability of the waveguide photodetector. Photolithographic patterning is employed on one or both side-edges of the coupling section to vary the shape of the coupling section (as observed from a top-view) and thereby modify the lateral coupling factor to the absorbing waveguide in successive portions. Top-view coupling section shapes are selected from the group consisting of rectangles, tapers, wedges, constant-width curved arcs, variable-width curved arcs, splines, corrugations, polygons that approximate exponentially decaying functions, and piecewise-linear polygons that approximate any arbitrary mathematical function.

It is to be appreciated that the absorbing component side edges within the absorbing waveguide may be manipulated to modify the lateral coupling factor between the coupling section and the absorbing waveguide. The top-view shape of the absorbing component can be modified independently from the shape of the coupling section. Top-view absorbing waveguide shapes are selected from the group consisting of rectangles, tapers, wedges, constant-width curved arcs, variable-width curved arcs, racetracks, teardrops, splines, corrugations, polygons that approximate exponentially decaying functions, and piecewise-linear polygons that approximate any arbitrary mathematical function. It is to be appreciated further that a curved coupling section waveguide can curve away from the absorbing waveguide, or towards the absorbing waveguide. Curved shapes are employed at the distal second end of the coupling section to maximize coupling efficiency and terminate any remaining light from back-reflection.

A design approach that fractures the coupling section into successive portions and uses computer algorithms to optimize design parameters may be utilized to achieve a coupling section that couples light of arbitrary polarization from the input waveguide to the absorbing waveguide with a variable coupling factor in each successive portion with minimal composite back-reflection. The coupling factor in successive portions of the coupling section vary from a small percentage in the initial portion, which is selected based on optical power handling requirements, to a large percentage in the last portion. It is to be appreciated that a progressively increasing coupling factor is achieved by combining different coupling section and absorbing component shapes stitched together in successive portions.

In one embodiment of the invention, more than one input waveguide strongly excites propagating modes in more than one coupling section or into two or more side-edges of an absorbing waveguide. An additional embodiment includes a single input waveguide and coupling section that laterally couples light to two absorbing waveguides that abut the two side-edges of one coupling section.

The method of using a side-edge coupling section laterally adjacent to an absorbing waveguide is applicable for coupling light from an input waveguide into an absorbing waveguide that possesses lateral doping profiles, layered vertical doping, or a combination of lateral and layered vertical doping in its structure. The described method is applicable for p-i-n, p-n, Schottky barrier, graphene, Avalanche photodetectors, and phototransistors. The described method is applicable to lumped-element and traveling-wave photodetectors.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIGS. 1A-C are exploded perspective views of basic components for a lateral waveguide photodetector coupler shown grouped into various embodiments in accordance with the present invention, wherein the number of components to be actually used (either added or omitted) for a particular embodiment, their individual type and shape, as well as their relative dimensions, orientations and separation distances in respective arrangements will depend on the intended cooperation of structure in a particular embodiment claimed for the invention;

FIGS. 1D and 1E are perspective views of basic components where FIG. 1D shows an embodiment in which a composite coupling section is composed of separated low-loss materials and one of the low-loss materials is in direct intimate contact with an assisting component of a waveguide photodetector, and FIG. 1E shows a separation space s between the coupling section and the absorbing waveguide:

FIGS. 2A and 2B are top plan views for embodiments of the present invention, where FIG. 2A shows a variable distance d between the coupling section and the absorbing component of the absorbing waveguide, and a variable width x for the absorbing component, and where FIG. 2B shows a tapered coupling section having a variable width w;

FIGS. 3A-C are each a cross section view of embodiments of the present invention as seen along the line 3A-C-3A-C in FIG. 2A, where FIG. 3A shows the absorbing component overlying the assisting component, FIG. 3B shows the absorbing component embedded in the assisting component, and FIG. 3C shows the incorporation of a composite coupling section with an absorbing waveguide;

FIG. 4A is a top plan view of an embodiment for the present invention showing a composite coupling section positioned for evanescent coupling with an absorbing waveguide, and FIG. 4B is a cross section view of the composite waveguide as seen along the line 4B-4B in FIG. 4A;

FIG. 5A is a cross section view of the embodiment of the present invention shown in FIG. 4A employing a composite coupling section, as would be seen along the line 5A-5A in FIG. 4A, and FIG. 5B is a cross section view of the embodiment shown in FIG. 4A as would be seen along the line 5B-51 in FIG. 4A, wherein a single composite coupling section component is shown positioned non-coplanar with the assisting component of the absorbing waveguide;

FIGS. 6A-C show different combinations of input waveguides, couplings sections and absorbing waveguides, where FIG. 6A shows a single coupling section butt coupled at opposite ends to respective different input waveguides, FIG. 6B shows two coupling sections with respective input waveguides positioned with a single absorbing waveguide therebetween, and FIG. 6C shows a single input waveguide coupled to a coupling section that is positioned laterally between absorbing waveguides;

FIG. 7 is a top plan of an embodiment for the present invention wherein the coupling section is curved away from the absorbing component of the absorbing waveguide; and

FIG. 8 is a top plan of an embodiment for the present invention wherein the coupling section is curved around the absorbing waveguide.

### DESCRIPTION OF THE PREFERRED EMBODIMENTS

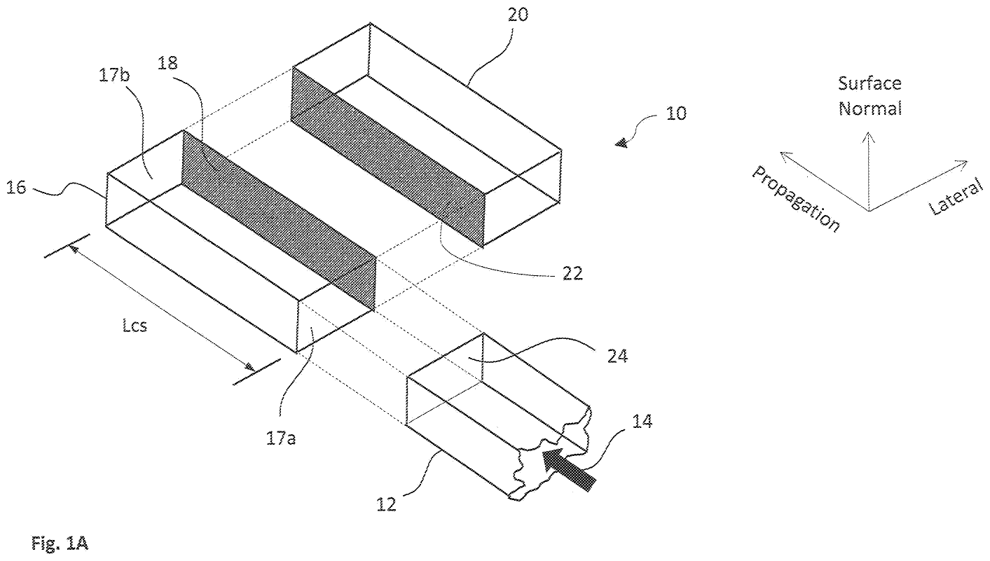

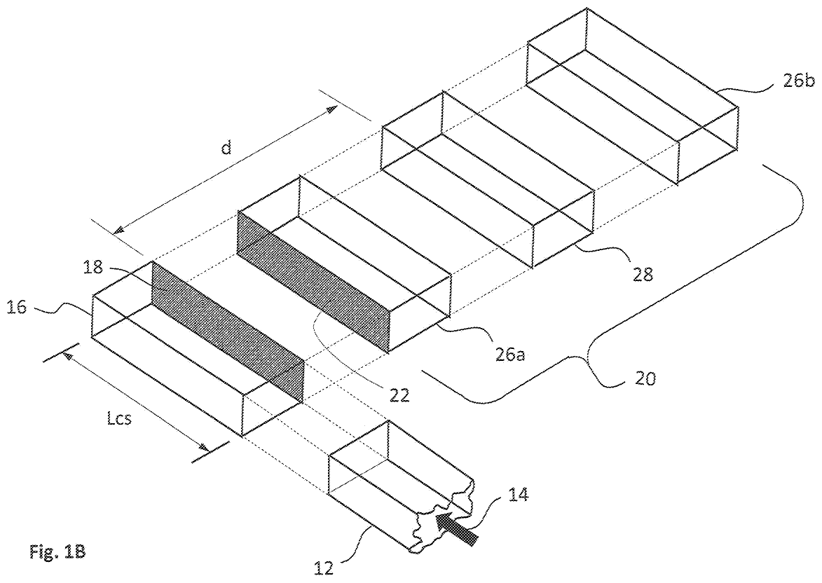

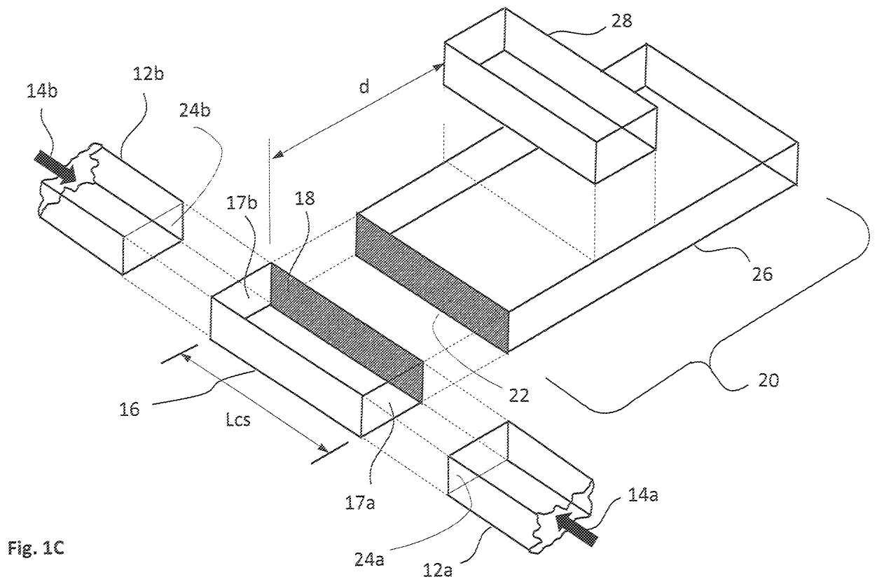

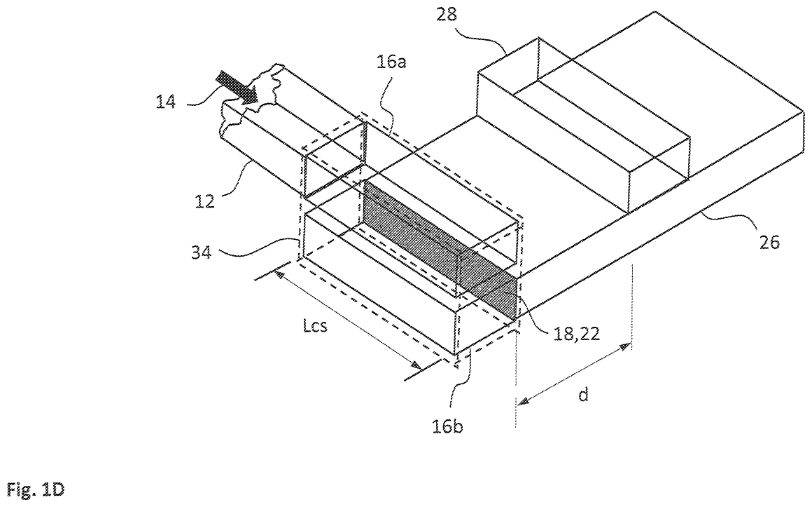

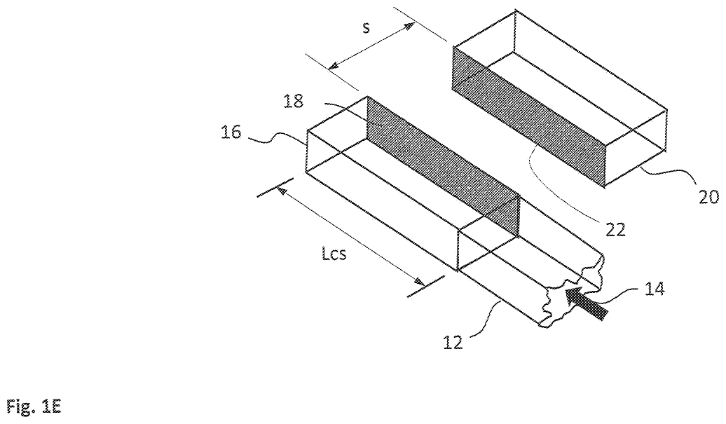

Referring initially to FIG. 1A a device in accordance with the present invention is shown and is generally designated 10. At the outset, it is to be appreciated that FIG. 1A shows only the essential components and their cooperative structure for a device 10. Moreover, it is to be appreciated that the dimensions and shapes of components shown in FIG. 1A are only exemplary of their structural and functional relationships with each other. As disclosed further below, the present invention envisions various arrangements of components for the device 10, which are manifested in a plurality of different embodiments (e.g., FIGS. 1B-E). All components shown in FIGS. 1A-E are considered separate structures, that may or may not be separated by a separation space s, depending on design considerations. Moreover, a variable distance d can also be engineered into spatial relationships between the various structures. As envisioned by the present invention, the separation space s and the surrounding medium can be filled with a low index, low loss material, such as Silicon Dioxide.

As shown in FIG. 1A, the essential device 10 includes an input waveguide 12 which is made of a low-loss material that carries an input optical signal 14. Further, an elongated coupling section 16 is included, which has first and second ends 17a and 17b, and is also made of a low-loss material. An important structural feature of the coupling section 16 is its long and narrow engagement side edge 18. As envisioned for the present invention, the engagement side edge 18 extends along the length L_{cs} from first end 17a to second end 17b of the coupling section 16 and can be either straight or curved. Additionally, the device 10 includes an absorbing waveguide 20 which includes a high-loss material. The absorbing waveguide 20 also defines a side surface area 22 that is dimensionally compatible with the engagement side edge 18 of the coupling section 16.

In combination, an exit end 24 of the input waveguide 12 is butt-coupled to the first end 17a of the coupling section 16. Also, the engagement side edge 18 of the coupling section 16 is positioned against the side surface area 22 of the absorbing waveguide 20. As indicated in FIG. 1A, for the essential device 10, there will be an indirect arrangement between the exit end 24 of the input waveguide 12 and the side surface area 22 of the absorbing waveguide 20, which are linked through the coupling section 16 and through engagement side edge 18.

For an operation of the essential device 10 (FIG. 1A), with reference to the directional indicators shown with FIGS. 1A-E, it is seen in FIG. 1A that the optical signal 14 will propagate from the input waveguide 12 into the coupling section 16, within the bounds of the engagement side edge 18, and through the length L_{cs}. As the optical signal 14 propagates through the coupling section 16, evanescence from the optical signal 14 is directed in a lateral direction from the coupling section 16 through the engagement side edge 18. This evanescence is also directed in the lateral direction through the side surface area 22 and into the absorbing waveguide 20.

FIG. 1B shows that the absorbing waveguide 20 includes both an assisting component 26 and an absorbing component 28. In this embodiment, the absorbing component 28 of absorbing waveguide 20 is embedded in the assisting component 26, separating the assisting component into a component 26a and a component 26b, wherein the assisting component 26a is positioned between the coupling section 16 and the absorbing component 28. The assisting component 26 will necessarily be a low-loss material, while the absorbing component 28 will be a high-loss material. FIG. 1B also indicates that the engagement side edge 18 of the coupling section 16, and the side surface area 22 of the absorbing waveguide 20 are compatibly dimensioned through the assisting component 26. The edge of the absorbing component 28 of the absorbing waveguide 20 is located at a distance d from the engagement side edge 18 of the coupling section 16. It is the assisting component 26a that establishes the side surface area 22 of the absorbing waveguide 20 and extends the distance d to the edge of the absorbing component 28.

In another embodiment of the present invention, FIG. 1C shows a combination where the absorbing component 28 of the absorbing waveguide 20 is not coplanar with its assisting component 26 and, instead, overlies the assisting component 26. Further, FIG. 1C indicates the present invention envisions the possibility of introducing multiple input optical signals 14a and 14b. As shown in FIG. 1C, a second input waveguide 12b carrying optical signal 14b and having an exit end 24b is butt-coupled to the second end 17b of coupling section 16. As disclosed in greater detail below, the use of multiple optical signals 14a and 14b is a design consideration that will depend on requirements for the intended use of a device 10.

Another embodiment of the present invention utilizes more than one material in the coupling section 16. FIG. 1D shows a primary coupling section component 16a that transfers power to a secondary coupling section component 16b that act together to create a composite coupling section 34. In this combination, the optical signal 14 propagates from the input waveguide 12 into primary coupling section 16a, co-propagates in both coupling section components 16a and 16b as power is transferred therebetween, and laterally couples through the engagement side edge 18 of the composite coupling section 34, to the assisting component 26.

FIG. 1E shows an embodiment wherein there is a separation space s between the engagement side edge 18 and the side surface area 22 of absorbing waveguide 20. As implied above, s can be an engineering consideration.

For purposes of the present invention, the coupling factor F is defined as a percentage measure of optical power transferred from the coupling section 16 to the absorbing component 28 of absorbing waveguide 20. Consider a configuration where the elongated coupling section 16 is subdivided along the length L_{cs} into an integer number j of successive portions. In this configuration, each portion has a length Lⱼ and respective area element Aⱼ of the engagement side edge 18, which is located at a distance dⱼ from the absorbing component 28 of the absorbing waveguide 20. A lateral coupling factor Fⱼ is established between each portion of the coupling section 16 and the absorbing component 28 of the absorbing waveguide 20.

The embodiment of FIG. 2A shows how shaping the absorbing component 28 of the absorbing waveguide 20 by adjusting the width xⱼ along the length L_{cs} results in a variable distance dⱼ between the engagement side edge 18 of the coupling section 16 and the absorbing component 28. A linear taper in the absorbing component 28 causes the width of the intermediary assisting component 26 to decrease linearly from d₁ to dⱼ. The embodiment of FIG. 2B shows how shaping the coupling section 16 is accomplished by adjusting the width wⱼ along the length L_{cs}. As envisioned for the present invention, wⱼ is an independent variable from dⱼ. Variations in xⱼ, dⱼ, and wⱼ may be incorporated in a same embodiment as shown in FIG. 26.

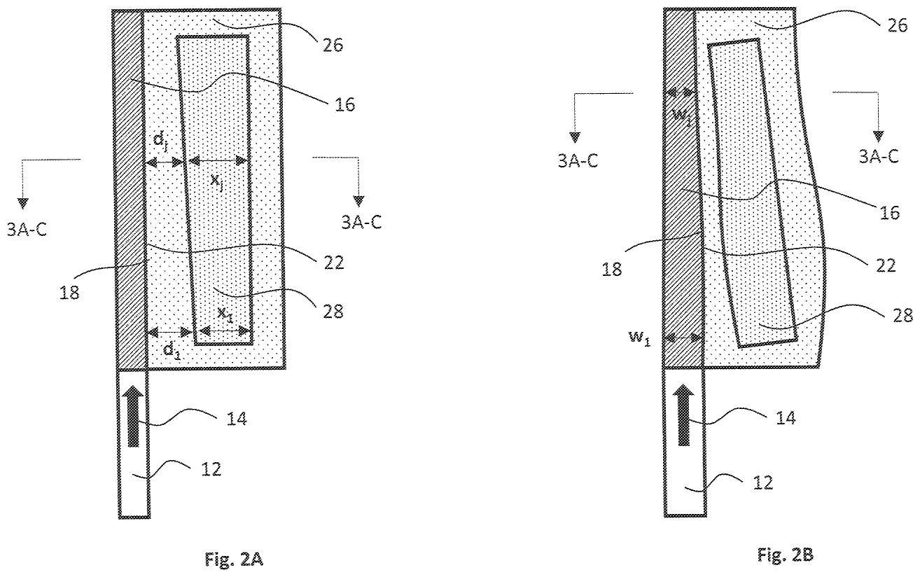

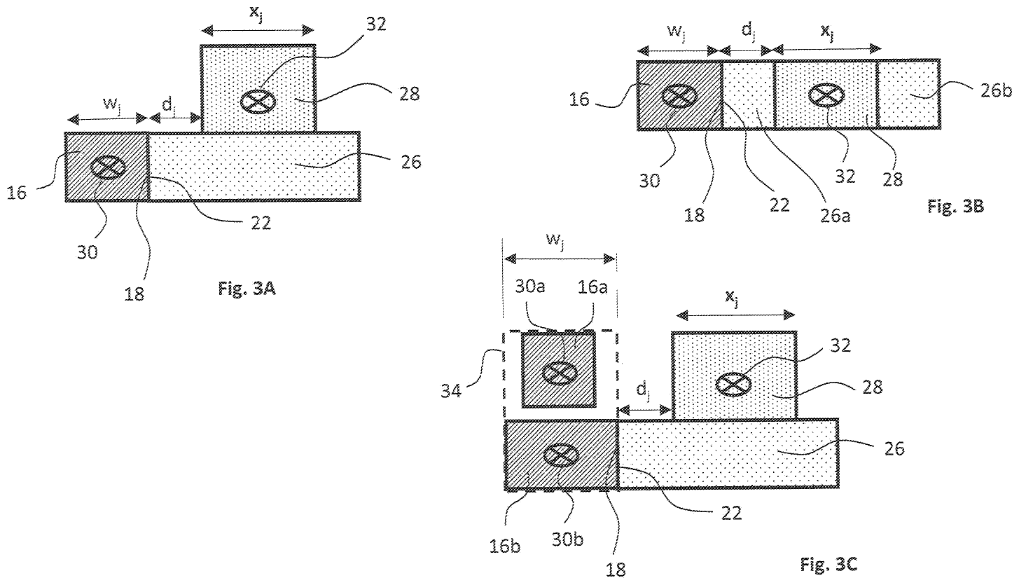

As shown in FIGS. 3A-C the coupling section 16 can take one of several cross sections. FIG. 3A shows a cross section based on an embodiment of FIG. 1C; FIG. 3B shows a cross section based on an embodiment of FIG. 1B; and FIG. 3C shows a cross section based on an embodiment of FIG. 1D. In these embodiments, the propagating optical mode 30 is guided within the extent of wⱼ and laterally offset from the absorbing center point 32 of absorbing component 28. The absorbing waveguide 20 typically supports multiple modes, therefore dⱼ and wⱼ are selected to control coupling and xⱼ is selected to ensure low back-reflection. As intended for the present invention, the initial portion coupling factor F₁ is selected to couple only a small fraction of the propagating optical mode 30 inside coupling section 16 to the absorbing center point 32 such that the optical power density remains under the threshold of saturation. In successive portions, a stronger coupling factor Fⱼ is chosen since the optical power is reduced compared to in the prior portion. The evanescent coupling factor Fⱼ is influenced both by proximity (the distance dⱼ through assisting component 26) and the width wⱼ of coupling section 16. Reduction in dⱼ and wⱼ both increase Fⱼ to uniformly distribute optical power along the length L_{cs}. With reference to FIG. 3A an embodiment of the present invention is shown wherein the absorbing component 28 of the absorbing waveguide 20 overlies the assisting component 26. In this configuration, evanescence from the propagating optical mode 30 in coupling section 16 is laterally directed through engagement side edge 18 and side surface area 22 into the assisting component 26 and from there, diagonally into the absorbing component 28. For the configuration shown in FIG. 3B, wherein the absorbing component 28 of the absorbing waveguide 20 is embedded in the assisting component 26 (e.g., portions 26a and 26b), evanescence from the propagating optical mode 30 in coupling section 16 is laterally directed into the assisting component 26a through engagement side edge 18 and side surface area 22. The evanescence then proceeds into the absorbing component 28, where the coupled optical mode is absorbed.

FIG. 3C shows a configuration for the device 10 that incorporates a composite coupling section 34. Specifically, as shown, the composite coupling section 34 includes a primary coupling section component 16a and a secondary coupling section component 16b. The primary coupling section component 16a contains a primary propagating optical mode 30a that has a weak initial interaction with side surface area 22 due to a distance larger than dⱼ. In successive portions, the primary propagating optical mode 30a gradually couples to the secondary propagating optical mode 30b in the secondary coupling section component 16b by vertical evanescent coupling. As the coupling to secondary propagating optical mode 30b increases, the lateral evanescent coupling from the secondary propagating optical mode 30b through the engagement side edge 18 to absorbing center point 32 also increases. This results in a continuous increase in Fⱼ from the standard operation of the composite coupling section 34.

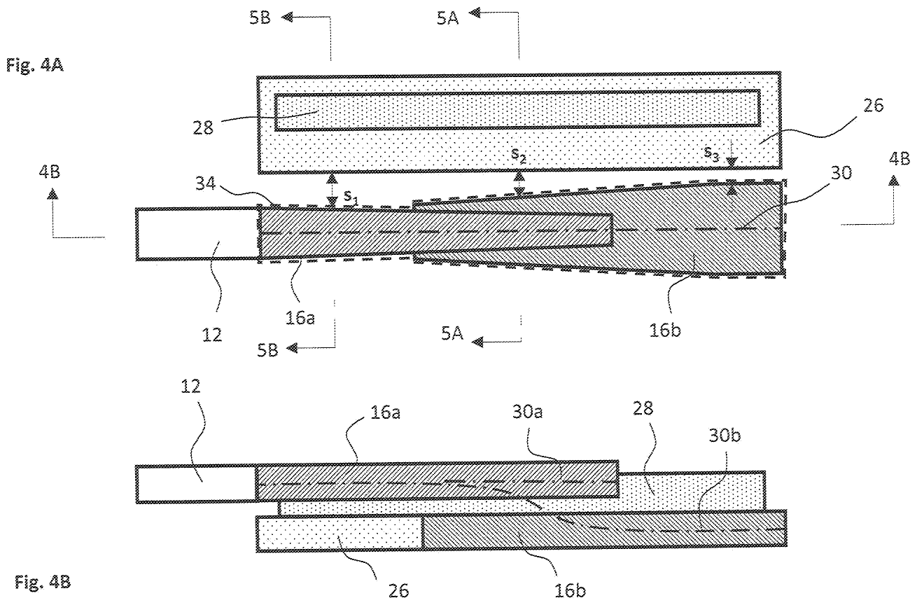

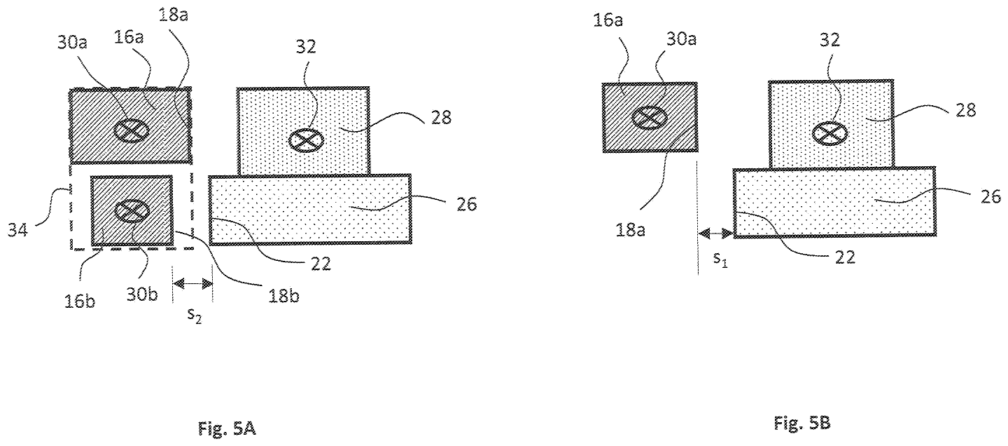

Yet another embodiment of the present invention is shown in the top view plan of FIG. 4A and cross section view thereof in FIG. 4B. This embodiment incorporates a lateral separation space s (see FIG. 1E) between the side surface area 22 of the absorbing waveguide 20 and engagement side edge 18 of the composite coupling section 34. This additional separation space s is particularly useful for further controlling the lateral evanescent coupling for very high-power propagating optical modes 30 in the composite coupling section 34. Lateral evanescent coupling across the separation space s introduces another fractional multiplicative factor to dilute the coupling factor Fⱼ due to the lower index of refraction of the material that fills the separation space s compared to other components 16a, 16b, and 26 of device 10. In this embodiment, the cross-section views of FIGS. 5A and 5B in conjunction with the top plan view 4A and elevation view 4B show three portions. In the first portion, exemplified by FIG. 5B, a large separation space s₁ and a diagonal offset between the engagement side edge 18a and side surface area 22 result in a dilute coupling factor F₁ to the assisting component 26. In an intermediate second portion exemplified by FIG. 5A, composite coupling from two coupling section components 16a and 16b through engagement side edges 18a and 18b respectively operate in parallel. The reduced separation space s₂ compared to s₁ results in an increased F₂ compared to F₁ for intermediate power handling. With reference to FIG. 5A it will be appreciated that in the second portion, the propagating optical mode 30a couples with the propagating optical mode 30b, which together then laterally couple to the assisting component 26 and into the absorbing center point 32. In a third portion, wherein only coupling section component 16b is present, the engagement side edge 18b is at a minimum separation space s₃ facing the side surface area 22 for this embodiment. It can be further appreciated, though not depicted, that once power intensity in propagating optical mode 30b is sufficiently low not to saturate absorbing component 28, in a last portion j, sⱼ is forced to zero by merging the secondary coupling section component 16b with assisting component 26. This final portion is exemplified by FIG. 3A or 3C, wherein the assisting component dimension dⱼ is adjusted as previously disclosed to efficiently absorb the residual power in propagating optical mode 30b.

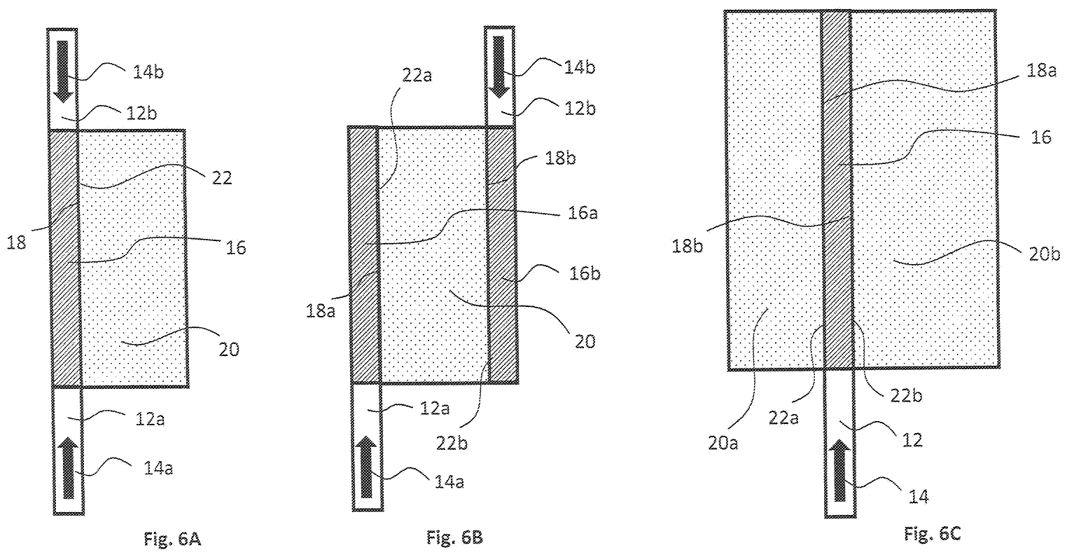

FIGS. 6A-C respectively show several different embodiments for the device 10 wherein more than one input waveguide (12a, 12b), coupling section (16a, 16b), or absorbing waveguide (20a, 20b) are incorporated. FIG. 6A shows an embodiment for the device 10, that includes input waveguides 12a and 12b which are respectively butt-coupled to opposite ends of a same coupling section 16 (see FIG. 1A). Optical signals 14a and 14b propagate in opposite directions from opposite ends of the coupling section 16. FIG. 6B shows an embodiment of the device 10 that includes a pair of coupling sections 16a and 16b which are incorporated on opposite sides of a same absorbing waveguide 20. As shown, the coupling sections 16a and 16b are respectively butt-coupled to input waveguides 12a and 12b. Optical signals 14a and 14b each propagate in their respective coupling sections 16a and 16b. FIG. 6C shows an embodiment of the device 10 wherein a single coupling section 16 is positioned laterally between a pair of absorbing waveguides 20a and 20b, wherein the optical signal 14 propagates into the coupling section 16 and its optical power is divided between the absorbing waveguides.

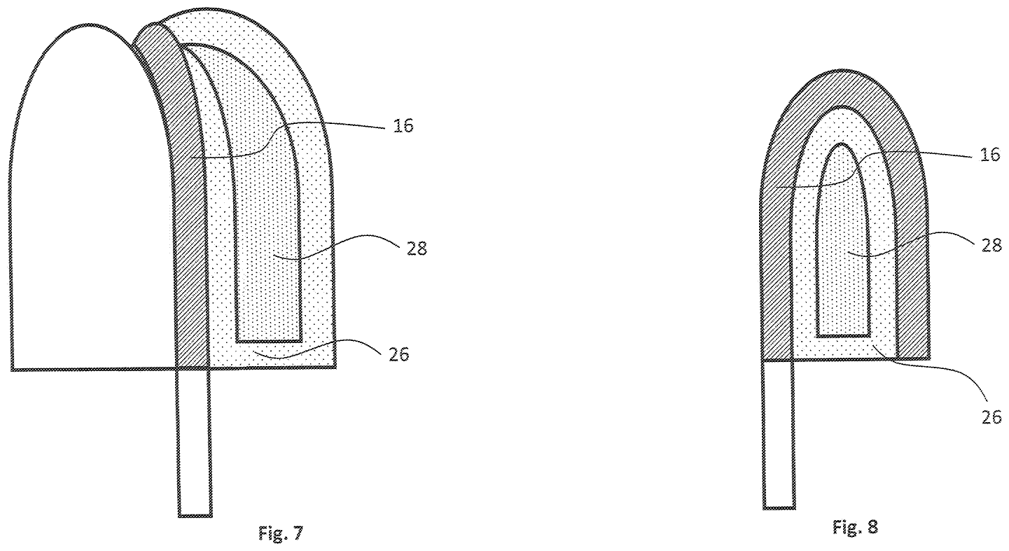

FIG. 7 and FIG. 8. are provided as additional examples that include curved coupling sections 16 for the device 10. Specifically, FIG. 7 is an example where a coupling section 16 can be curved away from the absorbing waveguide 20. On the other hand, FIG. 8 is exemplary of a coupling section 16 that curves around the absorbing waveguide 20.

While the particular Lateral Waveguide Photodetector Coupler as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for evanescently coupling an optical signal to an absorbing waveguide which comprises:
an input waveguide carrying the optical signal, the input waveguide having an exit end;
an elongated coupling section having a first end and a second end, wherein the first end of the coupling section is butt-coupled with the exit end of the input waveguide for receiving the optical signal therefrom with a propagating mode extending along a length L_{cs} between the first and second ends of the coupling section, wherein the coupling section defines an engagement side edge where evanescence of the optical signal is directed laterally from the coupling section and through the engagement side edge thereof; and
an absorbing waveguide, wherein the absorbing waveguide includes an absorbing component made of a high-loss material and an assisting component made of a low-loss material, wherein the absorbing waveguide defines a side surface area compatibly dimensioned with the engagement side edge of the coupling section, wherein the side surface area of the absorbing waveguide is in side-by-side contact with the engagement side edge of the coupling section along the length L_{cs}, for tracking therewith to evanescently couple the optical signal from the coupling section to the laterally displaced absorbing component of the absorbing waveguide.

2. The device of claim 1 wherein the elongated coupling section is subdivided along the length L_{cs} into an integer number j of successive portions, wherein each portion has a respective engagement side edge of length Lⱼ located at a distance dⱼ from the absorbing component of the absorbing waveguide, and wherein a lateral coupling factor Fⱼ is established therebetween.

3. The device of claim 2 wherein the successive coupling factors Fⱼ increase in a direction from the first end to the second end of the coupling section to uniformly distribute optical power along the length L_{cs}.

4. The device of claim 2 wherein the assisting component is positioned between the absorbing component of the absorbing waveguide and the engagement side edge of the coupling section, and wherein the assisting component establishes the side surface area of the absorbing waveguide.

5. The device of claim 2 wherein the elongated coupling section includes an upper surface and a lower surface equidistant and parallel to each other wherein for each portion of the coupling section in the length Lⱼ, the upper surface and the lower surface extend together in a lateral direction from the engagement side edge and away from the absorbing waveguide through a distance wⱼ, and wherein variations in wⱼ along the length L_{cs} shape the coupling section.

6. The device of claim 5 wherein shapes of the coupling section are selected from the group consisting of rectangles, tapers, inverse tapers, wedges, constant-width curved arcs, variable-width curved arcs, splines, corrugations and polygons.

7. The device of claim 5 wherein, independently of variations in the respective distances wⱼ for each portion of the coupling section, the distance dⱼ can be varied between the engagement side edge of a portion j of the coupling section and the absorbing component of the absorbing waveguide.

8. The device of claim 1 wherein the input waveguide, the elongated coupling section, and the assisting component of the absorbing waveguide each include a same low-loss material, and wherein the coupling section monolithically merges with the assisting component of the absorbing waveguide.

9. The device of claim 1 wherein the input waveguide and the coupling section are made of a material having an index of refraction η_{cs}, and the assisting component of the absorbing waveguide is made of materials with a composite index of refraction ηₐ, where ηₐ≈η_{cs} to establish a low index contrast between the engagement side edge of the coupling section and the side surface area of the assisting waveguide component.

10. The device of claim 1 wherein the elongated coupling section comprises:
a first layer made of a first low loss material;
an input waveguide made of the first low loss material, wherein the input waveguide is butt-coupled with the first layer of the coupling section; and
a second layer made of a second low loss material, wherein the second layer overlaps and is aligned with the first layer to establish an engagement side edge for the coupling section for contacting the second layer with the side surface area of an assisting component of the absorbing waveguide, wherein the assisting component is made of the second low loss material.

11. The device of claim 2 wherein the design parameters Lⱼ and dⱼ are variable to achieve polarization insensitive coupling of an optical signal of arbitrary polarization from an input waveguide.

12. The device of claim 1 wherein the input waveguide is a first input waveguide and the device further comprises a second input waveguide carrying a second optical signal, the second input waveguide having an exit end, wherein the second end of the coupling section is butt-coupled with the exit end of the second input waveguide for receiving the second optical signal therefrom with a propagating mode of the second optical signal extending along the length L_{cs} between the second and first ends of the coupling section, where evanescence of the second optical signal is directed laterally from the coupling section to the absorbing waveguide.

13. The device of claim 1 wherein the side surface area of the absorbing waveguide further includes an additional side surface area, and the device further comprises:
a second input waveguide carrying a second optical signal, the second input waveguide having an exit end; and
a second coupling section having a first end and a second end, and a second engagement side edge therebetween compatibly dimensioned with the additional side surface area of the absorbing waveguide, wherein the first end of the second coupling section is butt-coupled with the exit end of the second input waveguide for receiving the second optical signal therefrom, with a second propagating mode extending along a length L_{cs}′ between the first and second ends of the second coupling section to evanescently couple the second optical signal from the second coupling section through the second engagement side edge to the laterally displaced additional side surface area of the absorbing waveguide.

14. The device of claim 1 wherein the engagement side edge is a first engagement side edge and the coupling section has a second engagement side edge opposite the first engagement side edge in a lateral direction therefrom, and the device further comprises a second absorbing waveguide including a second absorbing component made of a high-loss material and a second assisting component made of a low-loss material, and having a second side surface area, wherein the second side surface area of the second absorbing waveguide is in side-by-side contact with the second engagement side edge of the coupling section along the length L_{cs}, for tracking therewith to evanescently couple the optical signal from the coupling section through the second engagement side edge to the second laterally displaced absorbing component of the second absorbing waveguide.

15. The device of claim 1 wherein the absorbing waveguide is incorporated as a structural component of a traveling-wave photodetector.

16. The device of claim 1 wherein the absorbing waveguide is incorporated as a structural component of a photodetector selected from the group consisting of p-i-n photodiode, p-n photodiode, Schottky barrier photodiode, graphene photodetector, Avalanche photodetector, and phototransistor.

17. The device of claim 16 wherein a doping profile for the selected photodetector is incorporated into the absorbing waveguide and is selected from the group consisting of lateral doping profiles, layered vertical doping, and a combination of lateral and layered vertical doping.

18. The device of claim 17 wherein a material system for the selected photodetector is selected from the group consisting of Silicon, Silicon-Carbide, Silicon-Germanium, Silicon-Nitride, III-V, II-VI, and hybrids of Silicon and III-V.

19. A device for evanescently coupling an optical signal to an absorbing waveguide which comprises:
an input waveguide carrying the optical signal;
an elongated coupling section made of a low-loss material having a first end and a second end with a length L_{cs} therebetween, wherein the first end of the coupling section is coupled to the input waveguide to receive the optical signal therefrom, and wherein the coupling section defines an engagement side edge along the length L_{cs} where evanescence of the optical signal is directed laterally from the coupling section and through the engagement side edge; and
an absorbing waveguide, wherein the absorbing waveguide defines a side surface area positioned in a side-by-side relationship with the engagement side edge of the coupling section along the length L_{cs}, with a separation space s therebetween for evanescently coupling the optical signal from the coupling section to the laterally displaced absorbing waveguide.

20. The device of claim 19 wherein the elongated coupling section is a composite coupling section with a first component made of a first low-loss material and having a first engagement side edge, and a second component made of a second low-loss material having a second engagement side edge and wherein the absorbing waveguide comprises an assisting component made of a low-loss material and having a first side surface area and an absorbing component made of a high-loss material having a second side surface area, where evanescence of the optical signal is directed laterally from the composite coupling section through the first engagement side edge to the first side surface area of the assisting component through a distance s, and evanescence of the optical signal is directed laterally from the composite coupling section through the second engagement side edge of the composite coupling section to the second side surface area of the absorbing component of the absorbing waveguide through a distance d.

21. The device of claim 19 wherein the elongated coupling section interacts with the absorbing waveguide to create a lateral coupling factor therebetween wherein the absorbing waveguide includes an absorbing component made of a high-loss material and an assisting component made of a low-loss material, and the side surface area is dimensionally compatible with the engagement side edge of the coupling section.

22. The device of claim 21 wherein the assisting component is positioned between the absorbing component of the absorbing waveguide and the engagement side edge of the coupling section, and wherein the coupling section is tapered with a decreasing cross section in the direction toward the second end of the coupling section, and the assisting component establishes the side surface area of the absorbing waveguide, and wherein a variable distance d is established by the assisting component of the absorbing waveguide between the engagement side edge of the coupling section and the absorbing component of the absorbing waveguide to uniformly distribute optical power along the length L_{cs}.

23. The device of claim 22 wherein the input waveguide is made of a material having an index of refraction ηⱼ and the coupling section is made of a material having an index of refraction η_{cs}, where ηⱼ≈η_{cs} to establish a low index contrast at the interface where the coupling section is butt-coupled to the input waveguide.

24. A method for evanescently coupling an optical signal to an absorbing waveguide which comprises the steps of:
providing an absorbing waveguide, wherein the absorbing waveguide includes an absorbing component made of a high-loss material and an assisting component made of a low-loss material, wherein the absorbing waveguide defines a side surface area;
creating an elongated coupling section having a first end and a second end with a length L_{cs} therebetween, wherein the coupling section defines an engagement side edge and supports a propagating mode extending along the length L_{cs};
dimensioning the engagement side edge of the coupling section, wherein the engagement side edge is compatibly dimensioned with the side surface area of the absorbing waveguide for side-by-side contact with the side surface area of the absorbing waveguide for tracking therewith; and
butt-coupling an input waveguide with the first end of the coupling section to transfer the optical signal to the coupling section, where evanescence from the optical signal is directed laterally from the coupling section and through the engagement side edge thereof toward the laterally displaced absorbing component of the absorbing waveguide.

25. The method of claim 24 further comprising the step of positioning the assisting component between the absorbing component of the absorbing waveguide and the engagement side edge of the coupling section, wherein the assisting component establishes the side surface area of the absorbing waveguide.

26. The method of claim 25 further comprising the steps of subdividing the elongated coupling section along the length L_{cs} into an integer number j of successive portions, wherein each portion has a respective engagement side edge of length Lⱼ located at a distance dⱼ from the absorbing component of the absorbing waveguide, and wherein a lateral coupling factor Fⱼ is established therebetween; and
calculating the coupling factors Fⱼ in a sequence to increase Fⱼ in a direction from the first end to the second end of the coupling section along the length L_{cs} to uniformly distribute optical power along the length L_{cs}.

27. The method of claim 26 further comprising the steps of:
shaping the elongated coupling section, wherein the coupling section includes an upper surface and a lower surface equidistant and parallel to each other, wherein for each portion of the coupling section in its length Lⱼ, the upper surface and the lower surface extend together from the engagement side edge through a distance wⱼ;
varying the respective distances wⱼ to shape the coupling section, wherein shapes of the coupling section are selected from the group consisting of rectangles, tapers, inverse tapers, wedges, constant-width curved arcs, variable-width curved arcs, splines, corrugations and polygons; and
adjusting the distance dⱼ between the engagement side edge of a portion j of the coupling section and the absorbing component of the absorbing waveguide to control coupling therebetween.
